(19) United States
(12) Patent Application Publication
(10) Pub. No.: US 2025/0279973 A1
(43) Pub. Date: Sep. 4, 2025

(54) METHOD AND APPARATUS FOR PROVIDING INSTANT MESSAGING SERVICE

(71) Applicant: KAKAO CORP., Jeju-si (KR)

(72) Inventors: Ji Soo YOUK, Seoul (KR); Min Ji SON, Seongnam-si (KR); Ji Hwan KIM, Seongnam-si (KR); Ha Neul LEE, Suwon-si (KR); Yu Ki KIM, Seongnam-si (KR); Ki Yong SONG, Seongnam-si (KR); Ho Geun KWAK, Seongnam-si (KR); Pil Gyu MIN, Seongnam-si (KR); Jong Uk LEE, Seongnam-si (KR)

(73) Assignee: KAKAO CORP., Jeju-si (KR)

(21) Appl. No.: 19/065,960

(22) Filed: Feb. 27, 2025

(30) Foreign Application Priority Data
Mar. 4, 2024 (KR) 10-2024-0030902

(51) Int. Cl. H04L 51/04; H04L 51/216

(52) U.S. Cl. CPC H04L 51/04; H04L 51/216

(57) ABSTRACT

Disclosed are a server providing an instant messaging service and an operating method of the server. The operating method of the server providing the instant messaging service, according to one embodiment, may include: determining, based on status information of a drive of an administrator of a first-type chat room and public backup setting information of the chat room, whether to enable public data corresponding to the chat room; when the public data is enabled, storing chat data sent and received within the chat room as the public data in the drive of the administrator; and providing the public data to a terminal of a participant in the chat room.

### CROSS-REFERENCE TO RELATED APPLICATIONS

This application claims priority under 35 USC § 119(a) to Korean Patent Application No. 10-2024-0030902 filed on Mar. 4, 2024, in the Korean Intellectual Property Office, the disclosure of which is incorporated by reference herein in its entirety.

### BACKGROUND

### Technical Field

The following embodiments relate to a server providing an instant messaging service and an operating method of the server.

### Description of Related Art

An instant messaging service, a service for sending and receiving messages between two or more users over a network, may be provided to users through a client program called an instant messenger. Unlike traditional instant messengers that send and receive messages in the form of text, recent instant messengers may support various functions such as sending and receiving various types of media files such as images, videos, and audio files, and sending and receiving data in groups while allowing two or more other users to communicate simultaneously. A growing increase in the use of such instant messengers on user devices such as mobile communication devices and personal computers (PCs) has increased the need for developing various convenient instant messaging service technologies that enable users to participate in various chat rooms to have conversations and/or share data with other participants.

### BRIEF SUMMARY

An aspect of the present disclosure is to provide an instant messaging service to fulfill various purposes of its users and provide an instant messaging technology that enables multiple users to share data sent and received through chat rooms efficiently.

An aspect of the present disclosure is to provide an instant messaging technology that may use a plurality of types of chat rooms with varying methods of managing data sent and received through the chat rooms.

However, technical challenges are not limited to the ones described above and there may also be other technical challenges.

According to an embodiment, there is provided an operating method of a server providing an instant messaging service, the operating method including: determining, based on status information of a drive of an administrator of a first-type chat room and public backup setting information of the chat room, whether to enable public data corresponding to the chat room; in response to the public data being enabled, storing chat data sent and received within the chat room as the public data in the drive of the administrator; and providing the public data to a terminal of a participant in the chat room.

The providing of the public data may include: receiving a request for the chat data from the participant in the chat room; and in response to the public data being enabled, acquiring the requested chat data from the public data stored in the drive of the administrator.

The chat data requested by the participant may include at least one of: chat data sent and received within the chat room before the participant joins the chat room; data for which a general backup condition corresponding to the participant has expired; or data for which a private backup condition corresponding to the participant has expired.

The status information of the drive of the administrator may be determined based on at least one of an account type of the administrator or a remaining capacity of the drive.

The determining of whether to enable the public data may include: in response to the account type of the administrator being a second account type, determining the public data to be disabled; and in response to the account type of the administrator being a first account type, determining whether to enable the public data based on the remaining capacity of the drive.

The determining of whether to enable the public data may include: in response to a public backup for the chat room being set to be disabled, determining the public data to be disabled.

The operating method may further include, in response to the public data corresponding to the chat room being determined to be disabled, deleting the public data stored in the drive of the administrator.

The operating method may further include storing the chat data in a drive of the participant, based on an account type of the participant in the chat room.

According to an embodiment, there is provided an operating method of a server providing an instant messaging service, the operating method including: receiving, from a participant in a first-type chat room, a request for chat data sent or received within the chat room; determining whether to enable public data corresponding to the chat room, based on status information of a drive of an administrator of the chat room and public backup setting information of the chat room; acquiring the requested chat data from public data stored in the drive of the administrator, based on whether the public data is enabled; and providing the requested chat data to a terminal of the participant.

The acquiring of the requested chat data may include: in response to the public data being enabled, determining whether the public data includes the requested chat data; and in response to the public data including the requested chat data, acquiring the requested chat data from the public data stored in the drive of the administrator.

The acquiring of the requested chat data may include, in response to the public data being disabled, acquiring the requested chat data from a drive of the participant based on an account type of the participant.

According to an embodiment, there is provided a server providing an instant messaging service, the server including a processor configured to: determine, based on status information of a drive of an administrator of a first-type chat room and public backup setting information of the chat room, whether to enable public data corresponding to the chat room; in response to the public data being enabled, store chat data sent and received within the chat room as the public data in the drive of the administrator; and provide the public data to a terminal of a participant in the chat room.

The processor may be configured to, when providing the public data, receive a request for the chat data from the participant in the chat room; and in response to the public data being enabled, acquire the requested chat data from the public data stored in the drive of the administrator.

The processor may be configured to, when determining whether to enable the public data, in response to an account type of the administrator being a second account type, determine the public data to be disabled; and in response to the account type of the administrator being a first account type, determine whether to enable the public data based on a remaining capacity of the drive.

The processor may be configured to, when determining whether to enable the public data, in response to a public backup for the chat room being set to be disabled, determine the public data to be disabled.

The processor may be configured to store the chat data in a drive of the participant, based on an account type of the participant in the chat room.

According to an embodiment, there is provided a server providing an instant messaging service, the server including a processor configured to: receive, from a participant in a first-type chat room, a request for chat data sent or received within the chat room; determine, based on status information of a drive of an administrator of the chat room and public backup setting information of the chat room, whether to enable public data corresponding to the chat room; based on whether the public data is enabled, acquire the requested chat data from public data stored in the drive of the administrator; and provide the requested chat data to a terminal of the participant.

The processor may be configured to, when acquiring the requested chat data, in response to the public data being enabled, determine whether the public data includes the requested chat data; and in response to the public data including the requested chat data, acquire the requested chat data from the public data stored in the drive of the administrator.

The processor may be configured to, when acquiring the requested chat data, in response to the public data being disabled, acquire the requested chat data from a drive of the participant based on an account type the participant.

Other features and aspects will be apparent from the following detailed description, the drawings, and the claims.

### BRIEF DESCRIPTION OF THE SEVERAL VIEWS OF THE DRAWINGS

The above and other features of certain embodiments of the present disclosure will be more apparent from the following detailed description, taken in conjunction with the accompanying drawings, in which:

FIG. 1 is a schematic diagram illustrating a system for an instant messaging service according to an embodiment;

FIG. 2 is a flowchart illustrating an operational flow of a server providing an instant messaging service according to an embodiment;

FIG. 3A is a diagram illustrating an example case where public data corresponding to a chat room is enabled according to an embodiment;

FIG. 3B is a diagram illustrating an example case where public data corresponding to a chat room is disabled according to an embodiment;

FIG. 4 is a diagram illustrating an example of chat data that may be acquired when public data corresponding to a chat room is enabled according to an embodiment;

FIG. 5 is a diagram illustrating an example of chat data that may be acquired when public data corresponding to a chat room is enabled after the chat room is created according to an embodiment;

FIG. 6 is a diagram illustrating an example of chat data that may be acquired when public data corresponding to a chat room is disabled according to an embodiment;

FIG. 7 is a flowchart illustrating an operating method of a server providing an instant messaging service according to an embodiment;

FIG. 8 is a flowchart illustrating a method of acquiring requested chat data according to an embodiment;

FIG. 9 is a diagram illustrating an example screen of a terminal of an administrator of a first-type chat room according to an embodiment; and

FIG. 10 is a diagram illustrating an example of a hardware configuration of a system for an instant messaging service according to an embodiment.

### DETAILED DESCRIPTION

The following detailed structural or functional description is provided only for the purpose of providing examples, and various alterations and modifications may be made to the examples. Here, the examples are not construed as limited to the disclosure and should be understood to include all changes, equivalents, and replacements within the idea and the technical scope of the disclosure.

The features described herein may be embodied in different forms and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

As used herein, the term “and/or” includes any one and any combination of any two or more of the associated listed items. The phrases “at least one of A, B, and C,” “at least one of A, B, or C,” and the like are intended to have disjunctive meanings, and these phrases “at least one of A, B, and C,” “at least one of A, B, or C,” and the like also include examples where there may be one or more of each of A, B, and/or C (e.g., any combination of one or more of each of A, B, and C), unless the corresponding description and embodiment necessitates such listings (e.g., “at least one of A, B, and C”) to be interpreted to have a conjunctive meaning.

Although terms such as first, second, and the like are used to describe various components, the components are not limited to the terms. These terms should be used only to distinguish one component from another component. For example, a first component may be referred to as a second component, and similarly the second component may also be referred to as the first component.

It should be noted that, if one component (e.g., a first component) is described as “connected,” “coupled,” or “joined” to another component (e.g., a second component), with or without the term “operatively” or “communicatively,” it is intended to indicate that the component may be connected to the other component directly (e.g., by wire), wirelessly, or through a third component.

The terminology used herein is for describing various examples only and is not to be used to limit the disclosure. The articles “a,” “an,” and “the” are intended to include the plural forms as well, unless the context clearly indicates otherwise. As used herein, the term “and/or” includes any one and any combination of any two or more of the associated listed items. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof.

Unless otherwise defined, all terms, including technical and scientific terms, used herein have the same meaning as commonly understood by one of ordinary skill in the art to which the present disclosure pertains. Terms, such as those defined in commonly used dictionaries, are to be interpreted as having a meaning that is consistent with their meaning in the context of the relevant art and the disclosure of the present application and is not to be interpreted in an idealized or overly formal sense unless expressly so defined herein.

Hereinafter, embodiments will be described in detail with reference to the accompanying drawings. When describing the embodiments with reference to the accompanying drawings, like reference numerals refer to like components and a repeated description related thereto will be omitted.

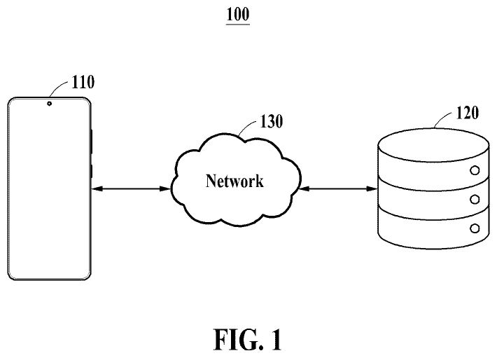

FIG. 1 is a schematic diagram illustrating a system for an instant messaging service according to an embodiment.

Referring to FIG. 1, according to one embodiment, a system 100 for an instant messaging service may include a terminal 110, a server 120, and a network 130. A specific hardware configuration of each of the server 120 and the terminal 110 is described below.

In one embodiment, the server 120 may include a server that provides the instant messaging service over the network 130. The instant messaging service may include a service that enables a plurality of users to chat in real time by transmitting instant messages such as text messages, voice messages, media files, and the like, in real time over the network 130 such as a wireless Internet or wireless communication network, and services related thereto.

The server 120 may interwork with an application (also “app” hereinafter) for the instant messaging service run on the terminal 110 for user interface (UI), functions, operations, services, or the like, or with a web for the instant messaging service. The app for the instant messaging service or the web for the instant messaging service may also be referred to hereinafter as an instant messenger.

The terminal 110 may be any electronic device, such as, a computer, a portable computer, a wireless phone, a mobile phone, a smartphone, a personal digital assistant (PDA), a web tablet, a wearable device, or any other device capable of installing and running an app or capable of running a web. In this case, the terminal 110 may receive services and/or content via the app or web. For example, the device 110 may perform service-wide operations, such as, configuring service screens, inputting data, transmitting and receiving data, storing data, or the like, under the control of the app or web. For example, the terminal 110 may process a UI or user interaction via a processor, and output or transmit a processing result acquired therefrom via an output device of the terminal 110.

The terminal 110 may be driven by the instant messenger provided by the server 120. A user may run the instant messenger on the terminal 110 to use the instant messaging service provided by the server 120. The user may subscribe to the instant messaging service via the instant messenger to create a user account. The user may use the instant messaging service by the terminal 110 of the account subscribed to the instant messaging service. The terminal 110 of the account subscribed to the instant messaging service may refer to a terminal logged in with the account subscribed to the instant messaging service.

In one embodiment, a chat interface may be provided to the terminal 110 via the app for the messaging service. The chat interface, which is an interface for sending and receiving messages in the messaging service, may include, for example, an interface that provides functions for sending messages through a chat room in which at least one user account participates and for displaying received messages. The chat interface may correspond to a chat room, which is a virtual space in which at least one user account participates and participants have chats with each other.

In one embodiment, the server 120 may provide different types of chat rooms including, for example, a first type of chat room (also “a first-type chat room” herein) and a second type of chat room (also “a second-type chat room” herein). The various types of chat rooms may differ from each other in at least one of the following: the presence or absence of an administrator, a method of joining (or participating in) a chat room, or a method of backing up chat data.

An administrator of a chat room may be a user or a user account that has management authority over the chat room. For example, the administrator of the chat room may have the authority to invite other users to join the chat room as participants. For example, the administrator of the chat room may have the authority to decide whether to accept a request to join the chat room received from another user. For example, the administrator of the chat room may have the authority to set announcements or notices in the chat room or manage chat data sent and received within the chat room. For example, the first-type chat room (e.g., a team chat room) may have an administrator, and the second-type chat room (e.g., a general chat room) may not have an administrator.

For example, the first-type chat room may be a chat room that requires an acceptance from an administrator for participation therein, whereas the second-type chat room may be a chat room that does not require an acceptance from another participant for participation therein.

For example, the first-type chat room may support both a public backup and a private backup of chat data sent and received within the chat room, and the second-type chat room may support the private backup but not the public backup.

A chat data backup method, which is a method of storing chat data sent and received within a chat room, may include, for example, a general backup method, a public backup method, and a private backup method.

The general backup method, which is a backup method supported by the server 120 for chat data by default, may store chat data as local data of a participant in a chat room or store it in a first database (DB), through a general backup. In this case, storing chat data as local data of a participant may indicate storing the chat data as the local data in a storage in a terminal (or device) of the participant. The first DB may be a temporary storage that stores chat data temporarily, and the chat data stored in the first DB may be deleted after a predetermined period of time elapses. The first DB may be available regardless of an account type of a participant.

The public backup method and the private backup method may be a method of storing chat data in a second DB. The second DB may correspond to a cloud storage that is separately allocated to a user account. The chat data stored in the second DB may be retained for an unlimited period of time. The second DB may be available only to a certain account type. For example, the second DB may be available only to a first account type (e.g., a paid account) of user. That is, the second DB may be allocated to a user of the first account type, allowing the user to store and retrieve data in and from the second DB which is the cloud storage, and may not be allocated to a second account type of user. The second DB may also be referred to hereinafter as a drive of a user or a user's drive.

The public backup method may correspond to a backup method by which chat data sent and received within a chat room is stored as public data available to participants in the chat room. For example, the public backup method may use the public backup to store the chat data as the public data in a drive of an administrator of the chat room. The public data may include data that may be shared by the participants in the chat room. The participants in the chat room may acquire chat data stored as the public data regardless of when they join the chat room. That is, the participants in the chat room may acquire, from the public data, chat data present even before they join the chat room.

The private backup method may correspond to a backup method by which chat data sent and received within a chat room is stored in a storage space that is accessible by an individual participant in the chat room. For example, the private backup method may use the private backup to store the chat data as private data in a drive of a participant in the chat room. The private data stored in the drive of the participant in the chat room may not be shared with other participants in the chat room. The private backup method may use the private backup to store chat data present after the participant joins the chat room as the private data in the drive of the participant. In a case where a chat room does not support the public backup, participants in that chat room may not be able to acquire chat data present before they join the chat room.

In one embodiment, the first-type chat room may include a team chat room, and the second-type chat room may include a general chat room. Unlike the general chat room, the team chat room may be a chat room that provides participants with a function for viewing or retrieving chat data that is present before they join the chat room. As described in more detail below, chat data in the team chat room may be stored as public data in a drive of an administrator of the chat room. The public data may be provided to participants in the team chat room. The participants in the team chat room may acquire chat data that has been stored as the public data before they join the chat room.

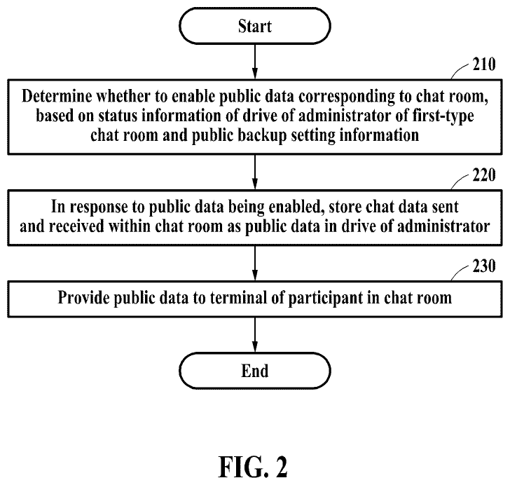

FIG. 2 is a flowchart illustrating an operational flow of a server providing an instant messaging service according to an embodiment.

Referring to FIG. 2, according to one embodiment, an operating method of a server providing an instant messaging service may include operation 210 of determining, based on status information of a drive of an administrator of a first-type chat room and public backup setting information of the chat room, whether to enable public data corresponding to the chat room.

In one embodiment, the status information of the drive of the administrator may be determined based on at least one of an account type of the administrator and a remaining capacity of the drive. For example, in a case where the account type of the administrator is a second account type, the drive of the administrator may be determined to be in an unavailable state. For example, in a case where the account type of the administrator is a first account type, the status information of the drive of the administrator may be determined based on the remaining capacity of the drive of the administrator. In this example, in a case where the account type of the administrator is the first account type, and the drive of the administrator has no remaining capacity or the remaining capacity is less than a threshold, the drive of the administrator may be determined to be in the unavailable state. Alternatively, in a case where the account type of the administrator is the first account type, and the drive of the administrator has a remaining capacity or the remaining capacity is greater than or equal to the threshold, the drive of the administrator may be determined to be in an available state. When the status information of the drive indicates a value of the unavailable state, the public data corresponding to the chat room may be determined to be disabled. When the status information of the drive indicates a value of the available state, the public data corresponding to the chat room may be determined to be enabled.

In one embodiment, operation 210 of determining whether to enable the public data may include determining the public data to be disabled in response to the account type of the administrator being the second account type, and determining whether to enable the public data based on the remaining capacity of the drive in response to the account type of the administrator being the first account type.

In one embodiment, operation 210 of determining whether to enable the public data may include determining the public data to be disabled when a public backup for the chat room is set to be disabled.

For example, the public data may be determined to be disabled when the public backup for the chat room is set to be disabled even though the status information of the drive indicates the value of the available state.

For example, the public data may be determined to be enabled when the status information of the drive indicates the value of the available state and the public backup of the chat room is set to be enabled.

For example, the public data may be determined to be disabled regardless of the public backup setting information of the chat room, when the status information of the drive indicates the value of the unavailable state.

The operating method of the server providing the instant messaging service, according to one embodiment, may include operation 220 of storing, when the public data is enabled, chat data sent and received within the chat room as the public data in the drive of the administrator.

The public data may be stored, based on the chat room. For example, in a case where a user is an administrator of a first chat room and an administrator of a second chat room, public data corresponding to the first chat room and public data corresponding to the second chat room may be stored in a drive of the administrator. The public data corresponding to the first chat room and the public data corresponding to the second chat room may be stored separately. For example, the public data corresponding to the first chat room may be stored by being indexed as identification information of the first chat room, and the public data corresponding to the second chat room may be stored by being indexed as identification information of the second chat room.

The public data in the drive of the administrator may also be stored separately from private data of the administrator. For example, the private data and the public data may be stored in different spaces in the drive of the administrator. For example, some space in the drive of the administrator may be allocated for storing the public data, and another space in the drive of the administrator may be allocated for storing the private data.

The operating method of the server providing the instant messaging service, according to one embodiment, may include deleting the public data stored in the drive of the administrator when the public data corresponding to the chat room is determined to be disabled.

After the public data corresponding to the chat room is determined to be disabled, chat data sent and received within that chat room may no longer be stored as the public data in the drive of the administrator. Subsequently, when the public data corresponding to the chat room is re-enabled, chat data after the public data is re-enabled may be stored as the public data in the drive of the administrator.

In one embodiment, the administrator of the chat room may change. When the administrator of the chat room is changed, whether to enable the public data corresponding to the chat room may be determined based on status information of a drive of the changed administrator. For example, in a case where the administrator of the chat room is changed to a user of the second account type, the public data may be determined to be disabled. For example, in a case where the administrator of the chat room is changed to a user of the first account type, the public data may be determined to be disabled when the drive of the administrator has no remaining capacity or has a remaining capacity that is less than the threshold. For example, in a case where the administrator of the chat room is changed to the user of the first account type, the drive of the administrator may be determined to be in the available state when the drive of the administrator has a remaining capacity or when the remaining capacity is greater than or equal to the threshold.

In a case where the public data corresponding to the chat room is determined to be enabled even when the administrator of the chat room is changed, chat data sent and received within the chat room may be stored as the public data in the drive of the changed administrator. In this case, chat data stored as the public data in the drive of the administrator (or former administrator) before the change may be transferred to the drive of the changed administrator (or new administrator). That is, when the administrator of the chat room is changed, the chat data of that chat room stored as the public data in the drive of the former administrator before the change may be deleted from the drive of the former administrator and stored in the drive of the new administrator.

In a case where the public data corresponding to the chat room is determined to be disabled when the administrator of the chat room is changed, the chat data may not be stored as the public data in the drive of the new administrator. The chat data of the chat room stored as the public data in the drive of the former administrator before the change may be deleted.

When the public data corresponding to the chat room is changed to be enabled after being disabled due to the change of the administrator, chat data sent and received within the chat room after the public data is enabled may be stored as the public data in the drive of the new administrator.

The operating method of the server providing the instant messaging service, according to one embodiment, may include operation 230 of providing the public data to a terminal of a participant in the chat room. The public data stored in the drive of the administrator corresponding to the chat room may be shared by terminals of participants in the chat room. For example, the terminal of the participant in the chat room may access the drive of the administrator to acquire the public data corresponding to the chat room. For example, the terminal of the participant may acquire, via the server, the public data stored in the drive of the administrator corresponding to the chat room.

In one embodiment, operation 230 of providing the public data may include receiving a request for chat data from the participant in the chat room and, when the public data is enabled, acquiring the requested chat data from the public data stored in the drive of the administrator. The chat data requested by the participant may correspond to data that is not stored in the terminal of the participant and/or a drive of the participant.

For example, the chat data requested by the participant may include chat data sent and received within the chat room before the participant joins the chat room.

For example, the chat data requested by the participant may include data for which a general backup condition corresponding to the participant has expired. As described above, the general backup may refer to storing data in a terminal of a participant or a first DB of the participant for a predetermined period of time. The general backup condition may correspond to a condition for storing data in a first DB of a participant and/or a terminal of the participant for a predetermined period of time. In this case, data stored after the predetermined period of time has elapsed after being stored may be deleted from the first DB of the participant and/or the terminal of the participant. For example, when the predetermined period of time is one week, the data stored in the first DB of the participant and/or the terminal of the participant for more than one week may correspond to the data for which the general backup condition has expired.

For example, the chat data requested by the participant may include data for which a private backup condition corresponding to the participant has expired. As described above, the personal backup may refer to storing data in a drive of a participant. The private backup condition may correspond to a condition for storing data in a drive in the available state. The private backup condition may expire when an account type of the participant is changed to the second account type, when the drive of the participant has no remaining capacity, or when the participant sets not to use the private backup for chat data. The data for which the private backup has expired may correspond to data that is generated after the account type of the participant is changed to the second account type, the drive of the participant has no remaining capacity, or the participant sets the private backup for chat data not to be used, and that is not to be stored in the drive of the participant.

The server may receive the request for the chat data from the terminal of the participant in the chat room and access the public data stored in the drive of the administrator. The server may transmit the requested chat data acquired from the public data to the terminal of the participant. For example, the requested chat data may be provided to the terminal of the participant via the chat room.

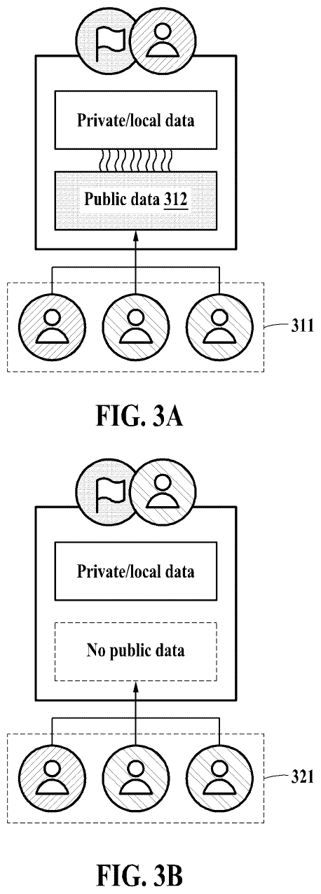

As an example, FIG. 3A is a diagram illustrating an example case where public data corresponding to a chat room is enabled according to an embodiment. Referring to FIG. 3A, participants 311 in a chat room may acquire public data 312 corresponding to the chat room stored in a drive of an administrator. In a case where a participant is a user of a first account type, the acquired public data may be stored or backed up in a drive of the participant through a private backup. In a case where a participant is a user of a second account type, the acquired public data may be stored or backed up in a terminal or a first DB of the participant through a general backup.

As an example, FIG. 3B is a diagram illustrating an example case where public data corresponding to a chat room is disabled according to an embodiment. Referring to FIG. 3B, when public data is disabled, chat data sent and received within a chat room may not be stored as public data in a drive of an administrator. Accordingly, there may be no public data corresponding to the chat room stored in the drive of the administrator. Thus, participants 321 in the chat room may not be able to acquire public data corresponding to the chat room from the drive of the administrator.

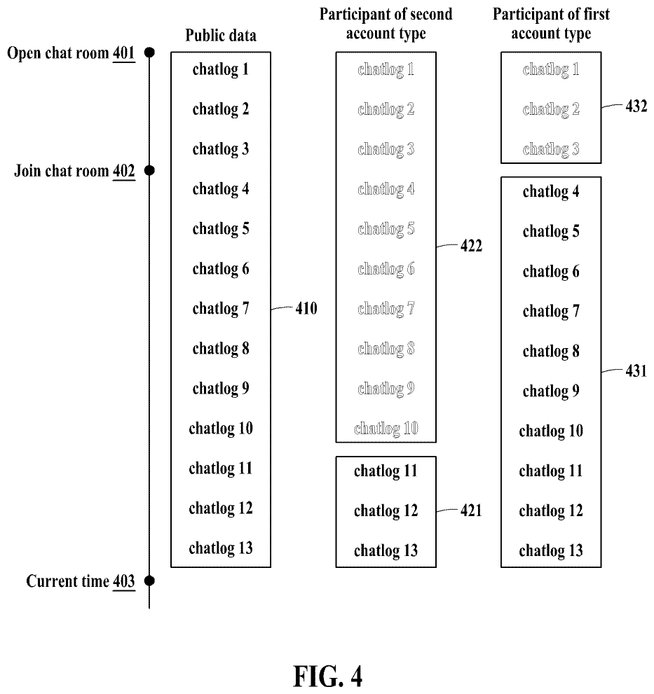

FIG. 4 is a diagram illustrating an example of chat data that may be acquired when public data corresponding to a chat room is enabled according to an embodiment.

Referring to FIG. 4, shown are chat data (e.g., chat logs) stored in a drive of an administrator of a chat room as public data corresponding to that chat room, chat data of the chat room that may be acquired by a participant (or a terminal of the participant) of a second account type, and chat data of the chat room that may be acquired by a participant (or a terminal of the participant) of a first account type.

For example, in a case where public data has been enabled since an opening time 401 at which a chat room was opened, chat data 410 sent and received within the chat room since the opening time 401 may be stored in a drive of an administrator as public data corresponding to the chat room.

For a participant of the second account type, a portion 421 of chat data after a joining time 402 at which the participant joined the chat room may be backed up by a general backup. For example, chat data sent and received within the chat room within three days from a current time 403 may be stored as private data in a drive of the participant or as local data in a terminal of the participant. In this case, chat data 422 that is not backed up by the general backup may be acquired from the public data corresponding to the chat room stored in the drive of the administrator. The chat data 422 that is not backed up by the general backup may include chat data before the joining time 402.

For a participant of the first account type, chat data 431 after a joining time 402 at which the participant joined the chat room may be backed up by a private backup in a terminal of the participant. That is, the chat data 431 after the joining time 402 may be stored as private data in a drive of the participant. At least a portion of chat data after the joining time 402 may be backed up by the general backup. For example, chat data sent and received within the chat room within three days from a current time may be stored as the private data in the drive of the participant or stored as local data in the terminal of the participant. In this case, chat data 432 that is not backed up by the private backup and/or general backup may be acquired as the participant of the first account type acquires chat data before the joining time 402 at which the participant joined the chat room from the public data. For example, the chat data 432 that is not backed up by the private backup and/or general backup may include the chat data sent and received within the chat room before the joining time 402 at which the participant of the first account type joined the chat room.

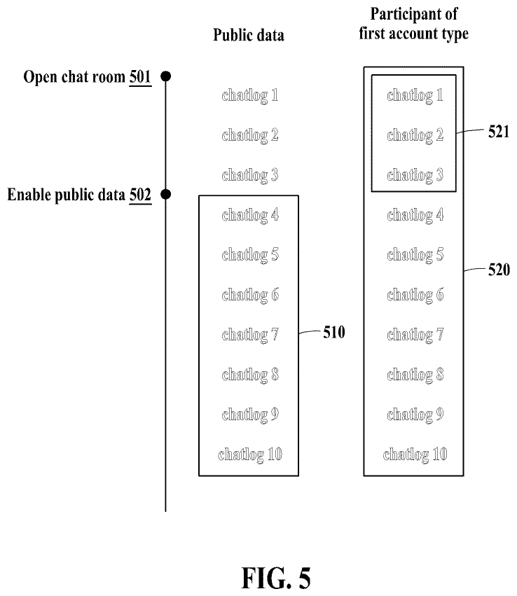

FIG. 5 is a diagram illustrating an example of chat data that may be acquired when public data corresponding to a chat room is enabled after the chat room is created according to an embodiment.

Referring to FIG. 5, shown are chat data (e.g., chat logs) stored in a drive of an administrator of a chat room as public data corresponding to the chat room and chat data of the chat room that may be acquired by a participant (or a terminal of the participant) of a first account type.

For example, in a case where public data is enabled at a certain time 502 after the chat room was opened, chat data 510 sent or received within the chat room from the time 502 at which the public data is enabled may be stored in a drive of an administrator as the public data corresponding to the chat room.

For a participant of the first account type, chat data 520 after a joining time 501 at which the participant joined the chat room may be backed up by a private backup in a drive of the participant. In a case where the joining time 501 at which the participant of the first account type joined the chat room is before the time 502 at which the public data is enabled, the chat data 520 that is backed up by the private backup in the drive of the participant may be more than the chat data 510 stored as the public data. In this case, of the chat data 520 stored in the drive of the participant of the first account type, chat data 521 that is not included in the public data may be uploaded as the public data. The public data may be updated to include the chat data 521 stored in the drive of the participant of the first account type.

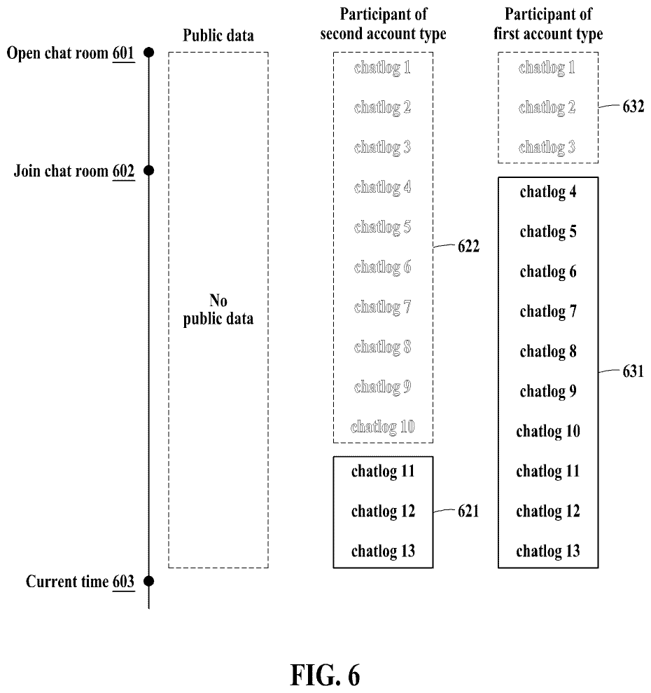

FIG. 6 is a diagram illustrating an example of chat data that may be acquired when public data corresponding to a chat room is disabled according to an embodiment.

Referring to FIG. 6, shown are chat data (e.g., chat logs) stored in a drive of an administrator of a chat room as public data corresponding to the chat room, chat data of the chat room that may be acquired by a participant (or a terminal of the participant) of a second account type, and chat data of the chat room that may be acquired by a participant (or a terminal of the participant) of a first account type.

For example, in a case where public data is disabled, chat data sent or received within a chat room may not be stored as public data.

For a participant of the second account type, a portion 621 of chat data after a joining time 602 at which the participant joined the chat room may be backed up by a general backup. For example, chat data sent and received within the chat room within three days from a current time 603 may be stored in a first DB or stored as local data in a terminal of the participant. Since there is no chat data stored as public data, chat data 622 that is not backed up by the general backup may not be acquired from public data corresponding to the chat room stored in a drive of an administrator of the chat room.

For a participant of the first account type, chat data 631 after a joining time 602 at which the participant joined the chat room may be backed up by a private backup in a drive of the participant. That is, the chat data 631 after the joining time 602 may be stored as private data in the drive of the participant. At least a portion of the chat data 631 after the joining time 602 may be backed up by the general backup. For example, chat data sent and received within the chat room within three days from a current time 603 may be stored as the private data in the drive of the participant or stored as local data in a terminal of the participant. Since there is no chat data stored as public data, chat data 632 that is not backed up by the private backup and/or general backup may not be acquired from public data corresponding to the chat room stored in the drive of the administrator.

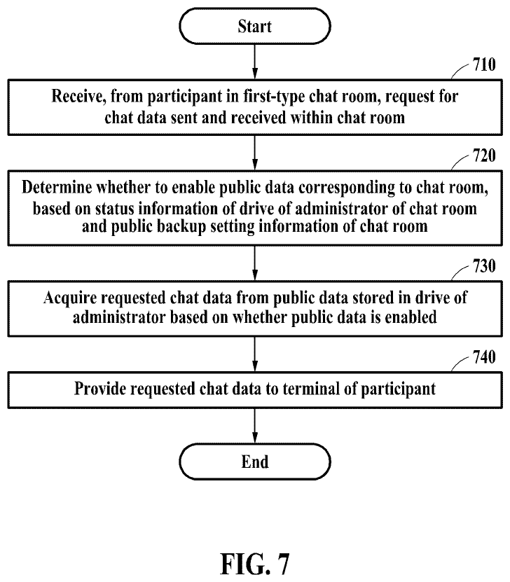

FIG. 7 is a flowchart illustrating an operating method of a server providing an instant messaging service according to an embodiment.

Referring to FIG. 7, an operating method of a server providing an instant messaging service, according to one embodiment, may include operation 710 of receiving, from a participant of a first-type chat room, a request for chat data sent or received within the chat room.

For example, the chat data requested by the participant may include at least one of chat data sent or received within the chat room before the participant joins the chat room, data for which a general backup condition corresponding to the participant has expired, and data for which a private backup condition corresponding to the participant has expired.

The operating method of the server providing the instant messaging service, according to one embodiment, may include operation 720 of determining whether to enable public data corresponding to the chat room based on status information of a drive of an administrator of the chat room and public backup setting information of the chat room. For example, operation 720 of determining whether to enable the public data corresponding to the chat room may correspond to operation 210 of determining whether to enable the public data, described above with reference to FIG. 1.

As described above, the status information of the drive of the administrator may be determined based on at least one of an account type of the administrator and a remaining capacity of the drive.

In one embodiment, operation 720 of determining whether to enable the public data may include determining the public data to be disabled when a public backup for the chat room is set to be disabled.

For example, the public data may be determined to be disabled when the public backup for the chat room is set to be disabled even though the status information of the drive indicates a value of an available state.

For example, the public data may be determined to be enabled when the status information of the drive indicates the value of the available state and the public backup for the chat room is set to be enabled.

The operating method of the server providing the instant messaging service, according to one embodiment, may include operation 730 of acquiring the requested chat data from the public data stored in the drive of the administrator, based on whether the public data is enabled.

In one embodiment, operation 730 of acquiring the requested chat data may include determining whether the requested chat data is included in the public data when the public data is enabled, and acquiring the requested chat data from the public data stored in the drive of the administrator when the requested chat data is included in the public data. For example, the server may determine whether the requested chat data is chat data sent or received within the chat room after the public data is enabled.

In one embodiment, operation 730 of acquiring the requested chat data may include acquiring the requested chat data from a drive of the participant based on an account type of the participant, when the public data is disabled. In this case, the chat data requested by the participant may include at least one of chat data sent or received within the chat room before the participant joins the chat room and data for which the general backup condition corresponding to the participant has expired, rather than data for which the private backup condition corresponding to the participant has expired. For the participant of a first account type, chat data may be backed up by a private backup in the drive of the participant. The server may acquire the requested chat data by referring to private data stored in the drive of the participant, when the public data is disabled.

The operating method of the server providing the instant messaging service, according to one embodiment, may include operation 740 of providing the requested chat data to a terminal of the participant. The requested chat data may be output via the chat room that has received the request.

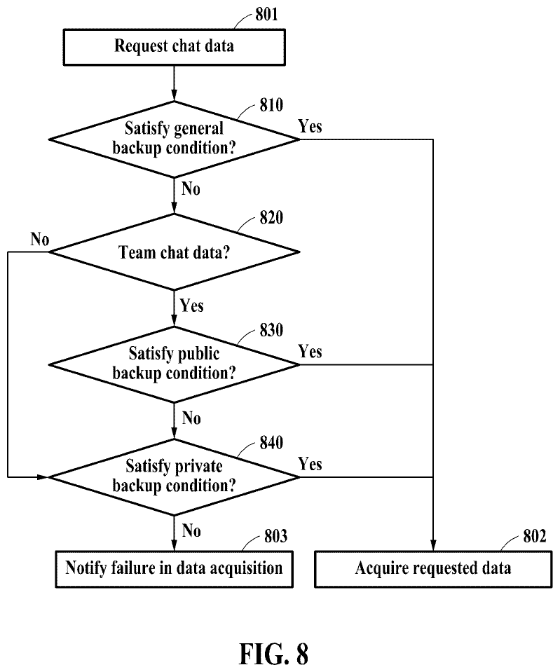

FIG. 8 is a flowchart illustrating a method of acquiring requested chat data according to an embodiment.

Referring to FIG. 8, a server may receive a request 801 for chat data from a user. The user may correspond to a participant in a chat room. The request 801 for the chat data may be received via the chat room. Upon receiving the request 801 for the chat data, the server may determine whether the requested chat data satisfies a general backup condition, at operation 810. When the general backup condition is satisfied, that is, when chat data stored in a first DB and/or terminal of the user is requested, the server may acquire requested data 802 by referring to the first DB of the user and/or a storage of the terminal of the user. The server may output the acquired requested data 802 through the chat room that has received the request 801.

When the general backup condition is not satisfied, that is, when chat data that is not stored in the first DB of the user and/or the terminal of the user is requested, the server may determine whether the chat data is team chat data, at operation 820. Whether the chat data is team chat data may correspond to whether the requested chat data is chat data sent or received within a first-type chat room.

When the requested chat data is team chat data, the server may determine whether the requested chat data satisfies a public backup condition, at operation 830. When the public backup condition is satisfied, that is, when chat data stored as public data corresponding to the chat room in a drive of an administrator is requested, the server may acquire the requested data 802 by referring to the public data. The server may output the acquired request data 802 through the chat room that has received the request 801.

When the requested chat data is team chat data and does not satisfy the public backup condition, the server may determine whether the requested chat data satisfies a private backup condition, at operation 840. When the private backup condition is satisfied, that is, when chat data stored as private data in a drive of the user is requested, the server may acquire the requested data 802 by referring to the drive of the user. The server may output the acquired requested data 802 through the chat room that has received the request 801.

When the private backup condition is not satisfied, that is, when chat data that is not stored in the drive of the user is requested, the server may provide a data acquisition failure notification to the terminal of the user, at operation 803. The data acquisition failure notification may include a message indicating that the acquisition of the requested chat data is unsuccessful.

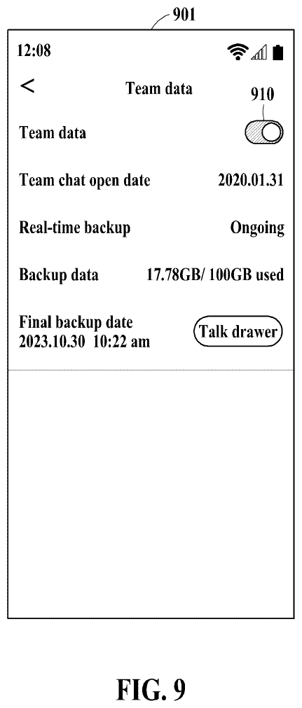

FIG. 9 is a diagram illustrating an example screen of a terminal of an administrator of a first-type chat room according to an embodiment.

Screen 901 of FIG. 9 may correspond to a screen provided on a terminal of an administrator for setting up a public backup for a first-type chat room. The screen 901 may correspond to a setup screen for the first-type chat room.

Referring to the screen 901, a setting value to indicate whether to enable the public backup for the chat room may be input via an interfacing object 910 for public backup settings. When the setting value that enables the public backup for the first-type chat room is input, chat data sent and received within that chat room may be stored as public data in a drive of the administrator. When the setting value that disables the public backup for the first-type chat room is input, chat data sent and received within that chat room may not be stored as the public data in the drive of the administrator.

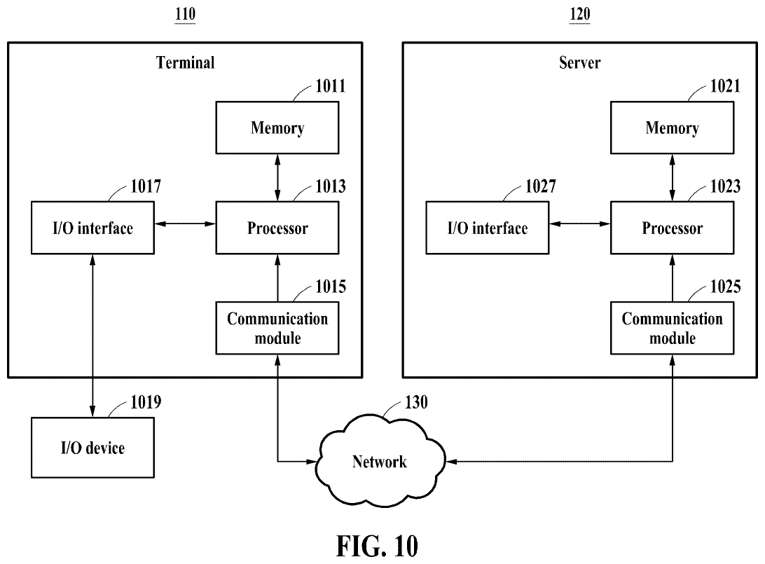

FIG. 10 is a diagram illustrating an example of a hardware configuration of a system for an instant messaging service according to an embodiment.

Referring to FIG. 10, according to one embodiment, a system (e.g., the system 100 of FIG. 1) may include a terminal 110 and a server 120 connected via a network 130.

In one embodiment, the terminal 110 may be a mobile terminal implemented as a computer device. For example, the terminal 110 may communicate with the server 120 and/or other electronic devices over the network 130 using a wireless or wired communication method.

In one embodiment, the server 120 may be implemented as a computer device or plurality of computer devices that communicates with the terminal 110 and/or other servers over the network 130 to provide commands, code, files, content, services, or the like. The communication method is not limited to a specific one and may include, for example, a communication method using a communication network (e.g., a mobile communication network, a wired Internet, a wireless Internet, a broadcast network, etc.) included in the network 130 and a short-range wireless communication method between devices. The network 130 may include, for example, any one or more of a personal area network (PAN), a local area network (LAN), a campus area network (CAN), a metropolitan area network (MAN), a wide area network (WAN), a broadband network (BBN), the Internet, or the like.

In one embodiment, the server 120 may provide a file for installing an application to the terminal 110 connected via the network 130. In this case, the terminal 110 may install the application (e.g., an instant messenger) using the file provided by the server 120. The terminal 110 may also connect to the server 120 and receive services or content provided by the server 120, under the control of an operating system (OS) and at least one program (e.g., a browser or the installed application) included in the terminal 110. For example, when the terminal 110 transmits a service request message to the server 120 over the network 130 under the control of the application, the server 120 may transmit a code corresponding to the service request message to the terminal 110, and the terminal 110 may configure and display a screen according to the code under the control of the application to provide content to a user.

In one embodiment, the terminal 110 and the server 120 may include memories 1011 and 1021, processors 1013 and 1023, communication modules 1015 and 1025, and input/output (I/O) interfaces 1017 and 1027, respectively.

In one embodiment, the processors 1013 and 1023 may perform at least one of the operations described above with reference to FIGS. 1 through 9. For example, the processor 1013 may perform the operations related to the instant messaging service described above with reference to FIGS. 1 through 9. For example, the processor 1023 may perform at least one of the operations of the server 120 providing the instant messaging service described above with reference to FIGS. 1 through 9. The processors 1013 and 1023 may be configured to process instructions from a computer program by performing basic arithmetic, logic, and I/O operations. The instructions may be provided to the processors 1013 and 1023 by the memories 1011 and 1021 or the communication modules 1015 and 1025.

The memories 1011 and 1021, which are computer-readable recording media, may be volatile memory or non-volatile memory. In one embodiment, the memories 1011 and 1021 may store information required for operating the instant messenger interworking with the server 120 described above with reference to FIGS. 1 through 9. For example, the memory 1021 may store account information of a user subscribed to the instant messaging service and chat room information.

In one embodiment, the memory 1011 may include code for the instant messenger installed on the terminal 110 and driven by the file provided by the server 120 over the network 130.

In one embodiment, the memory 1021 may store a program in which the operations for the instant messaging service described above with reference to FIGS. 1 through 9 are implemented.

In one embodiment, the communication modules 1015 and 1025 may provide functionality for the terminal 110 and the server 120 to communicate with each other over the network 130 and to communicate with other electronic devices or other servers.

For example, a request generated by the processor 1013 of the terminal 110 in accordance with the program code for the instant messenger stored in a recording device such as the memory 1011 may be transmitted to the server 120 over the network 130 under the control of the communication module 1015.

For example, control signals or commands, content, files, or the like provided under control of the processor 1023 of the server 120 may be received by the terminal 110 via the communication module 1015 of the terminal 110, through the communication module 1025 and the network 130.

In one embodiment, the I/O interfaces 1017 and 1027 may be means for interfacing with an I/O device 1019. For example, an input device may include a device such as a keyboard or mouse, and an output device may include a device such as a display for displaying a communication session of the application. For another example, the I/O interface 1017 may be a means for interfacing with a device that incorporates functionality for input and output into one, such as, a touchscreen. As a more specific example, the processor 1013 of the terminal 110 may display a service screen or content on the display via the I/O interface 1017 that is configured using data provided by the server 120 when processing instructions from a computer program loaded into the memory 1011. An input through the I/O device 1019 received from a user may be provided in a form that is processible by the processor 1013 of the terminal 110 via the I/O interface 1017.

In one embodiment, the terminal 110 and the server 120 may include other components not shown in FIG. 10. For example, the terminal 110 may be implemented to include at least a portion of the I/O device 1019 described above, or may further include other components such as a transceiver, a global positioning system (GPS) module, a camera, various sensors, a DB, or the like.

The embodiments described herein may be implemented using hardware components, software components and/or combinations thereof. A processing device may be implemented using one or more general-purpose or special purpose computers, such as, for example, a processor, a controller, an arithmetic logic unit (ALU), a digital signal processor, a microcomputer, a field programmable gate array (FPGA), a programmable logic unit (PLU), a microprocessor, or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciated that a processing device may include multiple processing elements and multiple types of processing elements. For example, a processing device may include multiple processors or a processor and a controller. In addition, different processing configurations are possible, such as, parallel processors.

The software may include a computer program, a piece of code, an instruction, or some combination thereof, to independently or collectively instruct or configure the processing device to operate as desired. The software and/or data may be embodied permanently or temporarily in any type of machine, component, physical or virtual equipment, computer storage medium or device, or in a propagated signal wave capable of providing instructions or data to or being interpreted by the processing device. The software also may be distributed over network-coupled computer systems so that the software is stored and executed in a distributed fashion. The software and data may be stored by one or more non-transitory computer-readable recording mediums.

The methods according to the above-described examples may be recorded in non-transitory computer-readable media including program instructions to implement various operations of the above-described examples. The media may also include, alone or in combination with the program instructions, data files, data structures, and the like. The program instructions recorded on the media may be those specially designed and constructed for the purposes of examples, or they may be of the kind well-known and available to those having skill in the computer software arts. Examples of non-transitory computer-readable media include magnetic media such as hard disks, floppy disks, and magnetic tape; optical media such as CD-ROM discs, DVDs, and/or Blue-ray discs; magneto-optical media such as optical discs; and hardware devices that are specially configured to store and perform program instructions, such as read-only memory (ROM), random access memory (RAM), flash memory (e.g., USB flash drives, memory cards, memory sticks, etc.), and the like. Examples of program instructions include both machine code, such as produced by a compiler, and files containing higher-level code that may be executed by the computer using an interpreter.

The above-described hardware devices may be configured to act as one or more software modules in order to perform the operations of the above-described examples, or vice versa.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

The various embodiments described above can be combined to provide further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. An operating method of a server providing an instant messaging service, the operating method comprising:
determining, based on status information of an administrator of a first-type chat room and public backup setting information of the chat room, whether public data corresponding to the chat room is in an available state;
in response to the public data being in the available state, storing chat data sent and received within the chat room as the public data in a drive of the administrator; and
providing the public data to a terminal of a participant in the chat room.

2. The operating method of claim 1, wherein the providing of the public data comprises:
receiving a request for the chat data from the participant in the chat room; and
in response to the public data being in the available state, acquiring the requested chat data from the public data stored in the drive of the administrator.

3. The operating method of claim 1, wherein the chat data requested by the participant comprises at least one of:
chat data sent and received within the chat room before the participant joins the chat room;
data for which a general backup condition corresponding to the participant has expired; or
data for which a private backup condition corresponding to the participant has expired.

4. The operating method of claim 1, wherein the status information of the administrator is determined based on at least one of an account type of the administrator or a remaining capacity of the drive.

5. The operating method of claim 1, wherein the determining of whether the public data is in the available state comprises:
in response to an account type of the administrator being a second account type, determining the public data to be in an unavailable state; and
in response to the account type of the administrator being a first account type, determining whether the public data is in the available state based on a remaining capacity of the drive.

6. The operating method of claim 1, wherein the determining of whether the public data is in the available state comprises:
in response to a public backup for the chat room being set to be disabled, determining the public data to be in an unavailable state.

7. The operating method of claim 1, further comprising:
in response to the public data corresponding to the chat room being in an unavailable state, deleting the public data stored in the drive of the administrator.

8. The operating method of claim 1, further comprising:
storing the chat data in a drive of the participant, based on an account type of the participant in the chat room.

9. An operating method of a server providing an instant messaging service, the operating method comprising:
receiving, from a participant in a first-type chat room, a request for chat data sent or received within the chat room;
acquiring, based on whether public data corresponding to the chat room is in an available state, the requested chat data from the public data stored in a drive of an administrator of the chat room; and
providing the requested chat data to a terminal of the participant,
wherein whether the public data is in the available state is determined based on status information of the administrator and public backup setting information of the chat room.

10. The operating method of claim 9, wherein the acquiring of the requested chat data comprises:
in response to the public data being in the available state, determining whether the public data includes the requested chat data; and
in response to the public data including the requested chat data, acquiring the requested chat data from the public data stored in the drive of the administrator.

11. The operating method of claim 9, wherein the acquiring of the requested chat data comprises:
in response to the public data being in an unavailable state, acquiring the requested chat data from a drive of the participant based on an account type of the participant.

12. A non-transitory computer-readable storage medium storing instructions that, when executed by one or more processors, cause the one or more processors to perform the operating method of claim 1.

13. A server providing an instant messaging service, the server comprising:
one or more processors configured to:
determine, based on status information of an administrator of a first-type chat room and public backup setting information of the chat room, whether public data corresponding to the chat room is in an available state;
in response to the public data being in the available state, store chat data sent and received within the chat room as the public data in a drive of the administrator; and
provide the public data to a terminal of a participant in the chat room.

14. The server of claim 13, wherein the one or more processors are configured to:
when providing the public data,
receive a request for the chat data from the participant in the chat room; and
in response to the public data being in the available state, acquire the requested chat data from the public data stored in the drive of the administrator.

15. The server of claim 13, wherein the one or more processors are configured to:
when determining whether the public data in the available state,
in response to an account type of the administrator being a second account type, determine the public data to be in an unavailable state; and
in response to the account type of the administrator being a first account type, determine whether the public data is in the available state based on a remaining capacity of the drive.

16. The server of claim 13, wherein the one or more processors are configured to:
when determining whether the public data is in the available state,
in response to a public backup for the chat room being set to be disabled, determine the public data to be in an unavailable state.

17. The server of claim 13, wherein the one or more processors are configured to:
based on an account type of the participant in the chat room, store the chat data in a drive of the participant.

18. A server providing an instant messaging service, the server comprising:
one or more processors configured to:
receive, from a participant in a first-type chat room, a request for chat data sent or received within the chat room;
acquire, based on whether public data corresponding to the chat room is in an available state, the requested chat data from the public data stored in a drive of an administrator of the chat room; and
provide the requested chat data to a terminal of the participant,
wherein whether the public data is in the available state is determined based on status information of the administrator and public backup setting information of the chat room.

19. The server of claim 18, wherein the one or more processors are configured to:
when acquiring the requested chat data,
in response to the public data being in the available state, determine whether the public data includes the requested chat data; and
in response to the public data including the requested chat data, acquire the requested chat data from the public data stored in the drive of the administrator.

20. The server of claim 18, wherein the one or more processors are configured to:
when acquiring the requested chat data,
in response to the public data being in an unavailable state, acquire the requested chat data from a drive of the participant based on an account type the participant.
